(19) United States
(12) Patent Application Publication
(10) Pub. No.: US 2013/0332185 A1
(43) Pub. Date: Dec. 12, 2013

(54) VISIT RECORD SYSTEM AND ASSOCIATED METHODS FOR MOBILE CARE NETWORK

(71) Applicant: CARESOURSE, Dayton, OH (US)

(72) Inventors: Samuel T. George, Dublin, OH (US); Birch W. Dunford, Dayton, OH (US); Matthew J. Hail, Springboro, OH (US)

(21) Appl. No.: 13/930,947

(22) Filed: Jun. 28, 2013

Related U.S. Application Data
(62) Division of application No. 13/911,646, filed on Jun. 6, 2013.
(60) Provisional application No. 61/656,165, filed on Jun. 6, 2012.

(51) Int. Cl. G06F 19/00

(52) U.S. Cl. CPC G06F 19/328
USPC 705/2

(57) ABSTRACT

A system and method for tracking and verifying encounters between case managers and members of a healthcare insurance network, the system comprising: a provider network server accessible via a communication network; the server comprising: a scheduling module for creating and assigning a visit and task schedule to a plurality of case managers, a tracking module for determining visit information of the plurality of case managers, tracking visit times, and determining the actual travel distance; a visit record module for administering visit records of the case managers; a verification module for capturing data input of a member's signature verifying a case manager's visit record; a communication module for bidirectionally communicating data input and member information such as tasks lists; and at least one mobile transmission unit operable for communicating with the provider network via the communication module.

### CROSS-REFERENCE TO RELATED APPLICATION(S)

This application is a divisional application of U.S. patent application Ser. No. 13/911,646, filed Jun. 6, 2013, and entitled “MOBILE CARE MANAGEMENT SYSTEMS AND ASSOCIATED METHODS” which claims priority to provisional application Ser. No. 61/656,165, filed Jun. 6, 2012, and entitled “MOBILE CARE MANAGEMENT SYSTEM AND ASSOCIATED METHODS,” the contents of which are incorporated in full by reference herein.

### BACKGROUND OF THE DISCLOSURE

1. Field of Disclosure

The present disclosure relates generally to systems and methods for tracking encounters between case managers and members of a healthcare insurance network, in particular, the present disclosure is directed to a mobile care management system and method that may include, for example, scheduling care plans, collecting and reporting information from field based personnel, and other functions on a wide variety of mobile devices in the context of work flow routed through a connected network.

2. Description of Related Art

The home healthcare industry is now a multi-billion dollar field. Instead of requiring Members to undergo prolonged hospital stays or frequent visits to a clinic, a home care agency brings the medical services to the Member's location. Payment for services rendered is primarily paid by federal and state Medicare and Medicaid programs through which patients are members. Patient/Member (hereinafter “Member”) well-being often depends on the visit and attendance compliance of the visiting nurse, aide, or therapist, for example. In addition, Medicare and Medicaid providers need to ensure that Members within their network are being provided with certain quality services. Accordingly, Case Managers (CS) representative of a Medicaid or Medicare provider network typically are required to meet with Members at remote locations to review the care and services rendered by care givers and to schedule follow up tasks, care, or services.

In this regard, CS are often dispatched to a Member's home to perform required healthcare assessments, tasks, and other vital services. The frequency and length of time of a visit and the care provided by the CS are important to obtaining a positive outcome and improving the health of the Members. Thus, it is important to ensure compliance by the CS in attending the needed visits, and knowing what tasks and services are required for the specific Member. An additional role of the CS is to track such activities. As will be expected, the performance of a CS also needs to be managed. Tracking the duration of the actual visit of a CS to a Member's home is thus important. System administrators of a provider network are responsible for processing visit data records generated by the CS.

Certain existing reporting systems and processes rely on the CS to self report their visit attendance performance. Disadvantageously, at times this results in increased miscommunication, fraud, and abuse by the visiting CS. The administrative staff of the provider network is faced with monitoring the off-site personnel by spot-checking visit attendance data or relying on Member complaints or feedback.

Another disadvantage to such self-reporting procedures is that the reporting is generally self-documented by CS on paper reports. A full time CS employee can perform over 1000 visits a year, which could require a typical administrative staff person to spend an average of five minutes or more per employee visit to process and enter the information into appropriate systems. This can be inefficient and costly. Accordingly, there is a need for a system that provides for improved monitoring, reporting, data communication, and/or tracking of information relating to field service personnel such as CS in the home healthcare field.

Conventionally, in more complex task oriented business processes, task lists and form data are initially dispatched to CS using voice channel (e.g., cell phone) or pre-printed paper forms (e.g., clip board) that is then manually filled out or updated by the CS at a remote location. A completed task might require one or many subsequent tasks to be performed that are typically done and verified through a call over a cell phone, the submission of an e-mail form, or a return trip to the office. Today, CS may also capture data in the field so as to verify their completed tasks by using a series of paper forms and binders to complete their inspection tasks, resulting in a slow and inefficient process. In an attempt to address the shortcomings of paper-based forms, companies have moved to electronic based systems and related types solutions used in an e-mail system. However, the distribution of these forms has significant shortcomings. By way of example, a persistent difficulty with these conventional systems is performance monitoring of the CS. Heretofore, there has been no effective system or method for determining the veracity of reports delivered by the CS. Nor is there known an effective system or method for “real-time” updates of tasks to be completed by a CS, or for assisting a CS with a problem in “real time”. Current e-mail type systems undesirably result in a time delay for information exchange.

In addition, companies and CS field reps have increasingly relied upon mobile transmission units (mobile units) such as cell phones, Smartphones, iPads, PDA(s) with mobile data phones, tablets and the like for providing and transmitting critical up-to-date information relative to their tasks. Undesirably, these types of devices have numerous limitations. By way of example, the use of a mobile transmission unit currently requires a complex implementation and deployment structure to be integrated within a enterprise type network. Therefore, it would be desirable to provide a mobile web application capable of achieving all of the desired characteristics of a management care system and method while overcoming the noted shortcomings of conventional systems and methods.

### SUMMARY OF DISCLOSURE

The system and method of the present disclosure overcomes the shortcomings of conventional systems and methods by providing a Case Manager field rep (CS) with a mobile communication device or unit that is communicably linked or connected to a provider network having at least one computing server and is adapted for providing and collecting data that is time- and date-sensitive. In all example embodiments, the present disclosure is directed to a system and method for acquiring and transmitting real-time data on and by a CS deployed to a remote site for the purpose of performing a duty for a Medicaid or Medicare provider network. In exemplary embodiments, the mobile transmission unit provided to the CS is a Smartphone or similar device configured to connect to mobile web application that prompts the CS with a plurality of information and queries related to assigned tasks generated from a task list. In addition, the mobile web application is configured to accept and receive collected or captured data (e.g., Member signatures verifying a CS completed task or CS data input) at a central location for monitoring and processing. Real-time feedback may be provided to the CS for the purpose of improving performance in the field.

In exemplary embodiments, the system for acquiring and transmitting real-time data on and by a CS deployed to a remote site for the purpose of performing a duty for a Medicaid or Medicare provider network includes one or more mobile transmission devices communicably linked or connected to a computing server of a provider network for bidirectional communication. The bidirectional communications are preferably over the Internet using a secure protocol. Where the mobile device is a cell phone, a smartphone or a tablet device, a gateway may be provided to communicate data and transmissions from the mobile device to the provider network. The mobile device may be provided with software, hardware, or firmware which includes various modules or features to allow the mobile device to act as a client device with respect to the provider network. The mobile device may connect to the provider network and download a mobile web application related to Member care. Alternatively, the mobile device may include one or more resident applications and associated data storage that can be configured to provide one or more of the modules or features. The mobile web application may include one or more of the following modules or features:

Require a user to enter a username and/or password to prevent unauthorized access to the mobile device;

Display CS visits and tasks associated with one or more Members;

Exchange, update, approve, and/or deny scheduling of CS visits or follow up tasks for Members;

Transmit CS position updates to the provider network using GPS or other tracking features;

Accept data input from the user for an upcoming or current visit to the residence or current location of a Member;

Download from provider network a task to be performed by the CS during the visit;

Dynamically render on the mobile device one or more electronic data collection forms or fields;

Prompt the CS to enter data corresponding to the electronic data collection forms or fields;

Accept and validate data entered into the electronic data collection forms by the CS;

Transmit the entered data and/or completed electronic data collection forms to the provider network;

Capture Member verification that a CS performed services; and

Receive messages and alerts from the provider network that relate to updated task lists.

In exemplary embodiments, a method is also disclosed, the method including the steps of providing to a CS a mobile transmission unit or device that is in signal communication with a mobile web application that is in connection with a provider network. The CS connects to the provider network through the mobile web application and downloads and views scheduled visits for one or more Members of a health insurance provider network and/or task lists associated with the one or more Members. In example embodiments, the task list is organized by date ranges, with the most recent task situated at the top of the list. The CS may sort or reorganize the task list by a variety of factors, including the urgency/priority, the date/time, or the member. Thereafter, the CS may select a task to complete.

Upon selecting a task, the CS may be provided with information fields for review. The information fields may include, the Member name, the date/time, the priority, a subject line and notes. In example embodiments, the Member name information field may include information such as the member ID, the member gender, the member age, the member DOB, and/or the member contact information.

Subsequent to reviewing the information fields for the selected task, the CS may perform the task by selecting activities associated with the task from a predefined list. The CS may also select a place of contact from a list. The CS may then enter notes or comments containing details of the actions performed. The CS may also enter the mileage associated with the task in a predefined field. The CS may also capture the signature of the Member, thereby verifying that the assigned tasks were completed. The CS may save the data and information to the mobile device or transmit it directly to the provider network. At the time of the save function, a location and time feature will correspondingly capture and record the location and time of the save.

The saved information may be sent to the provider network server to populate progress notes. Once the information is populated to the provider network server, the task will be removed from the task list. In example embodiments, a notice may be sent to the CS via a text message or an e-mail which may be accessed via the mobile device. In additional embodiments, the task list may be periodically updated with new tasks. In such instances, the CS may be notified of the new addition, or the task list may be automatically updated and sorted based upon the urgency/priority of the task.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

The present subject matter may take form in various components and arrangements of components, and in various steps and arrangements of steps. The appended drawings are only for purposes of illustrating exemplary embodiments and are not to be construed as limiting the subject matter.

FIG. 1 is a schematic system diagram illustrating an exemplary managed care management system constructed in accordance with an exemplary implementation of the present disclosure;

FIG. 2 is a simplified block diagram illustrating representative modules that may be included in one or more implementations of the present disclosure;

FIG. 3 is a schematic diagram of an exemplary mobile computing application which may be resident or downloaded onto a mobile transmission device for communication with a provider network system in accordance with the present disclosure;

FIG. 4 is a schematic diagram for a exemplary software architecture of a mobile computing application which may be resident or downloaded onto a mobile transmission device for communication with a provider network system in accordance with present disclosure;

FIG. 5 is a web application class diagram of an exemplary system in accordance with the present disclosure;

FIG. 6 is a data diagram of an exemplary system in accordance with the present disclosure;

FIG. 7A is a diagram of view of an exemplary system in accordance with the present disclosure;

FIG. 7B is a diagram of audit tables of an exemplary system in accordance with the present disclosure;

FIG. 8 is an example display of a screen view of a non-authenticated home screen of the mobile care management system that is accessible by a browser through a mobile device;

FIG. 9 is an example display of a screen view of a logon screen of the mobile care management system that is accessible by a browser through a mobile device;

FIG. 10 is an example display of a screen view of a authenticated user home screen of the mobile care management system that is accessible by a browser through a mobile device;

FIG. 11 is an example display of a screen view of a task list screen of the mobile care management system that is accessible by a browser through a mobile device;

FIG. 12 is an example display of a screen view of a task list options screen of the mobile care management system that is accessible by a browser through a mobile device;

FIG. 13 is an example display of a screen view of a task list options grouped by values screen of the mobile care management system that is accessible by a browser through a mobile device;

FIG. 14 is an example display of a screen view of a completed task list screen of the mobile care management system that is accessible by a browser through a mobile device;

FIG. 15 is an example display of a screen view of a task list filter screen of the mobile care management system that is accessible by a browser through a mobile device;

FIG. 16 is an example display of a screen view of a task list one week view screen of the mobile care management system that is accessible by a browser through a mobile device;

FIG. 17 is an example display of a screen view of a task list ordered by priority screen of the mobile care management system that is accessible by a browser through a mobile device;

FIG. 18 is an example display of a screen view of an overdue tasks screen of the mobile care management system that is accessible by a browser through a mobile device;

FIG. 19 is an example display of a screen view of a task completion screen of the mobile care management system that is accessible by a browser through a mobile device;

FIG. 20 is an example display of a screen view of a task completion screen of the mobile care management system that is accessible by a browser through a mobile device;

FIG. 21 is an example display of a screen view of a task completion screen of the mobile care management system that is accessible by a browser through a mobile device;

FIG. 22 is an example display of a screen view of a task completion screen of the mobile care management system that is accessible by a browser through a mobile device;

FIG. 23 is an example display of a screen view of a signature capture screen of the mobile care management system that is accessible by a browser through a mobile device;

FIG. 24 is an example display of a screen view of a signature capture continued screen of the mobile care management system that is accessible by a browser through a mobile device;

FIG. 25 is an example display of a screen view of a create follow up task screen of the mobile care management system that is accessible by a browser through a mobile device;

FIG. 26 is an example display of a screen view of a create follow up task continued screen of the mobile care management system that is accessible by a browser through a mobile device;

FIG. 27 is an example display of a screen view of a Member information screen of the mobile care management system that is accessible by a browser through a mobile device;

FIG. 28 is an example display of a screen view of a Member tasks screen of the mobile care management system that is accessible by a browser through a mobile device;

FIG. 29 is an example display of a screen view of a contact forms screen of the mobile care management system that is accessible by a browser through a mobile device; and

FIG. 30 is a flow chart illustrating an mobile care management application constructed in accordance with an exemplary embodiment of the present disclosure.

### DETAILED DESCRIPTION OF PREFERRED EMBODIMENTS

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As stated above, the system and method of the present disclosure overcomes the shortcomings of conventional systems and methods by providing a Case Manager field rep (“CS”) of a Medicaid or Medicare provider with a mobile transmission device or unit that is configured to connect to a provider network server or a provider enterprise network (hereinafter “provider network”) via a mobile web application and is also adapted for transmitting to and receiving data from the provider network and for collecting data that is time- and date-sensitive related to a Member visit. Further, the system and method of the present disclosure overcomes the shortcomings of conventional systems and methods by providing the ability to send and receive scheduling data related to a CS visit schedule or a Member task list. Still further, the system and method of the present disclosure overcomes the shortcomings of conventional systems and methods by providing the ability to capture a signature of a Member utilizing touch screen technology as a verification that an interaction/encounter took place and/or that a task was performed. Still further, the system and method of the present disclosure overcomes the shortcomings of conventional systems and methods by providing the ability for a CS to receive and search current tasks (encounters) assigned to them by date, assigned member, priority and status. Still further, the system and method of the present disclosure overcomes the shortcomings of conventional systems and methods by providing the ability to search all Members currently enrolled within the provider network. Search results may include demographic information, preventative care alerts, and the healthcare information. Still further, the system and method of the present disclosure overcomes the shortcomings of conventional systems and methods by providing the ability to utilize the mobile device's current location function or mapping function to allow the user to call from or display directions to the Member's location.

In all example embodiments, the present invention is directed to a system and method for acquiring data on and by a CS deployed to a remote site for the purpose of performing a task for a health insurance, Medicare, or Medicaid provider. In exemplary embodiments, a mobile care management (MCM) application is provided which may be utilized by field deployed CS so as to track and manage a daily task log for interactions/encounters with Members of a health insurance provider network. In example embodiments, the method and system includes at least one computing server system communicably and bidirectionally linked to a client device or mobile device. In example embodiments, the system and method includes a MCM which includes various modules related to visit and task scheduling, visit records, CS position and tracking, Member verification of services, supply order fulfillment, administrator center control, and enterprise application integration. In example embodiments, once a CS accesses the MCM, the provider, through a provider network, may transmit to the mobile device a visit and task list associated with one or more Members. By transmitting this information, the CS will know what Members are on his or her schedule, what tasks need to be performed, and a visit record may be generated.

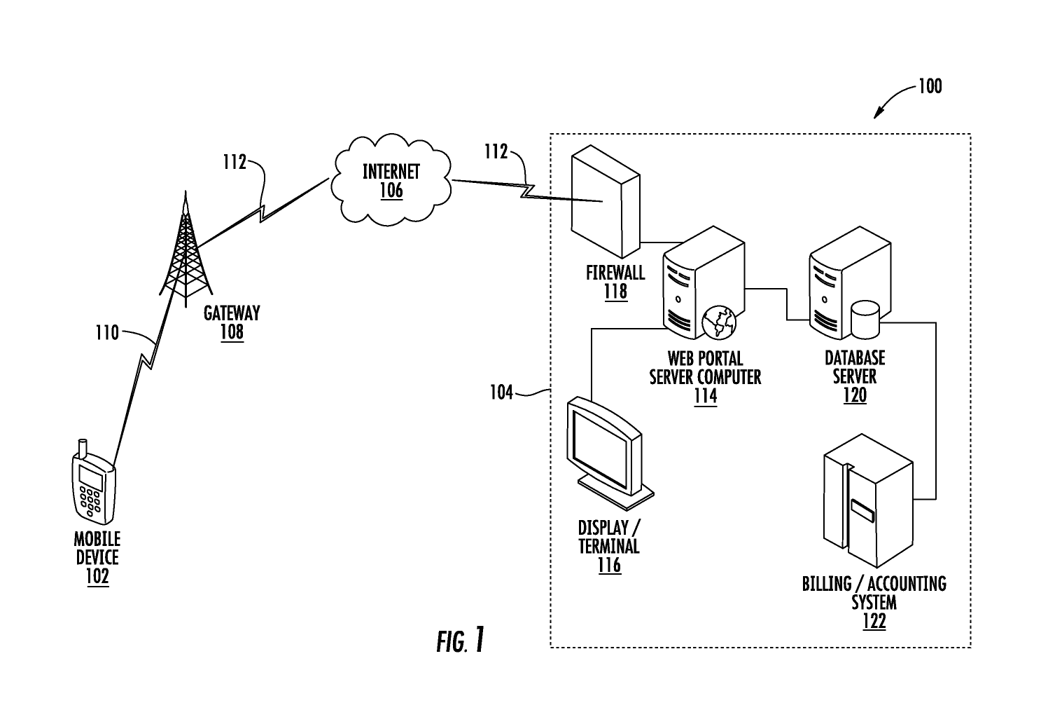

Referring now to FIG. 1, one example embodiment of a MCM system 100 is shown. As shown, the MCM may include one or more mobile transmission devices 102 that may be used by a CS or caregiver to bidirectionally communicate 110, 112 with a provider network or base/office server system 104. In one or more embodiments, the mobile transmission device 102 may comprise a cell phone, a Smartphone, or a multi-touch device having a touch sensing surface (e.g., track pod or touch screen) with the ability to recognize the presence of two or more points of contact with the surface. Examples of a multi-touch devices include mobile devices (e.g., iPhone™, Nexus™ Android™ devices, etc.), tablet computers (e.g., iPad™, Surface™, Galaxy Tab™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs). In other example embodiments, the provider network 104 is the Care Advance network owned by Caresource, Inc. In still other example embodiments, the bidirectional communications 112 are preferably over the Internet 106, which the mobile device 102 may access through a gateway 108. As will be appreciated by those skilled in the art, the bidirectional communications 112 may be via any communications network (which may be either of, or a combination of a fixed-wire or wireless LAN, WAN, intranet, extranet, peer-to-peer network, virtual private network, the Internet, or other communications network) with a number of client computing environments such as tablet personal computer, mobile telephone, telephone, personal computer, and personal digital assistance. In a network environment in which the communications network is the Internet 106, for example, the provider network 104 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Additionally, the networked computing environment can utilize various data security protocols such as HTTPS (HyperText Transfer Protocol with SSL (Secure Socket Layer) encryption for security) or pretty good privacy (PGP). Each client computing environment can be equipped with operating system operable to support one or more computing applications, such as a web browser such as MICROSOFT INTERNET EXPLORER™, MOZILLA FIREFOX™, OPERA™, APPLE SAFARI™ etc. (not shown), or other graphical user interface (not shown), or a mobile desktop environment (not shown) to gain access to server computing environment. In example embodiments, the software executing on client devices may be downloaded from the server computing environment and installed as a plug in or ACTIVEX™ control of a web browser.

Where the mobile device 102 is a cell or smartphone phone, the gateway 108 may comprise a cellular tower, base station, and Internet gateway, so that the mobile device 102 communicates with the gateway 108 via a cellular signal 110. Other alternatives for facilitating wireless bidirectional communications could call for the gateway 108 being a wireless gateway at a Member's home or a private or municipal WiFi access point. The particular implementation of the bidirectional communication link between the mobile device 102 and the server system 104 may vary depending on what systems are available in the relevant home care region being serviced. The frequency of data transmissions will depend on the particular activity that is in process; however, a typical schedule might be a morning download to obtain schedule information, along with periodic transmissions as visits are completed.

In example embodiments, the mobile device 102 is preferably a small (easily portable) wireless device that includes at least a display and a data entry mechanism, such as a keypad, keyboard, touchscreen, and/or voice-recognition input system. Other physical features that may be included as part of the mobile device 102 are (a) a transceiver, such as a cellular phone and/or wireless modem (data transmissions would preferably made using a cell phone's data plan), (b) an imaging device, such as a digital camera and/or video camera, (c) a GPS (Global Positioning System) module, (d) an RFID (Radio-Frequency Identification) module, and/or (e) a Bluetooth (or other PAN (Personal Area Network) module. The mobile device 102 is preferably carried by each home-care staff person and/or caregiver that operates in the field. These may include, for example, nurse aides, nurses, therapists, physician assistants, and other medical technicians and/or professionals.

To provide the functionality afforded by various embodiments of the present invention, the mobile device 102 preferably includes software, hardware, firmware, or a combination of these, to allow the mobile device 102 to act as a client device with respect to the provider network 104. As such, the mobile device preferably includes one or more resident software applications and associated data storage so that the mobile device 102 can be configured to provide one or more of the following example features:

Require a user to enter a username and/or password to prevent unauthorized access to the mobile device;

Display CS visits and tasks associated with one or more Members;

Exchange, update, approve, and/or deny scheduling of CS visits or follow up tasks for Members;

Transmit CS position updates to the provider network using GPS or other tracking features;

Accept data input from the user for an upcoming or current visit to the residence or current location of a Member;

Download from provider network a task to be performed by the CS during the visit;

Dynamically render on the mobile device one or more electronic data collection forms or fields;

Prompt the CS to enter data corresponding to the electronic data collection forms or fields;

Accept and validate data entered into the electronic data collection forms by the CS;

Transmit the entered data and/or completed electronic data collection forms to the provider network;

Capture Member verification that a CS performed services; and

Receive messages and alerts from the provider network that relate to updated task lists.

The above features are merely examples of some of the functionality that may be provided on the mobile device 102, in accordance with various embodiments of the present invention. These features may be supported by a set of application components written in programming languages such as mobile computing languages (e.g. Asp.Net 4-MVC 3, HTML5, jQuery Mobile, J2ME or BREW), running on the mobile device 102.

The provider network 104 in the illustrated embodiment includes a web portal server computer 114 and one or more associated displays 116, a firewall 118, one or more database servers 120, and a billing/accounting system 122. The provider network 104 may be a centralized nation-wide central system that provides administration services for several or many home care offices in different regions. Alternatively, one or more dedicated provider network 104 may be employed throughout various regions. Multiple provider networks 104 and/or multiple components within the provider network 104 may be included in order to provide redundancy and/or load balancing.

The server computer 114 acts as a server to the mobile device 102 and is preferably provided with a software based web server application that performs many actions such as dynamically managing workforce schedules; viewing, editing and approving visit records; archiving completed visits; and reporting based on monitoring and communicating visit information with the mobile device 102 used by CS and or other home-care staff in the field. Since bidirectional communications with the mobile device 102 are preferably made over the Internet 106, the server computer 114 is preferably connected to the Internet 106 through the firewall 118.

In example embodiments, the one or more displays/terminals 116 may be used by office-based staff to create, modify, and otherwise interact with care plans, Member information, staff schedules, and other data. Examples of such devices 116 include desktop PCs, laptop computers, Tablet PCs, workstations, or any computer devices running on any Operating System that can connect to a World Wide Web server, retrieve, and display web pages.

In example embodiments, the database server 120 may configured to store various types of data that provide assistance in the management and administration of information, such as visit records and field service monitoring reports, obtained as a result of activities (such as home care visits) performed by CS or field service personnel. The database server 120 may be coupled to a local or remote corporate billing/accounting system 122 to provide appropriate billing information based on tasks performed by the CS. The one or more databases are preferably of any RDBMS (Relational Database Management System) based. For example, a care plan may be maintained as a table having rows and columns corresponding to the stored fields. XML (eXtensible Markup Language) based data structure with associated tags and metadata are preferably used for storing and sharing the home care information among the components of the system 100.

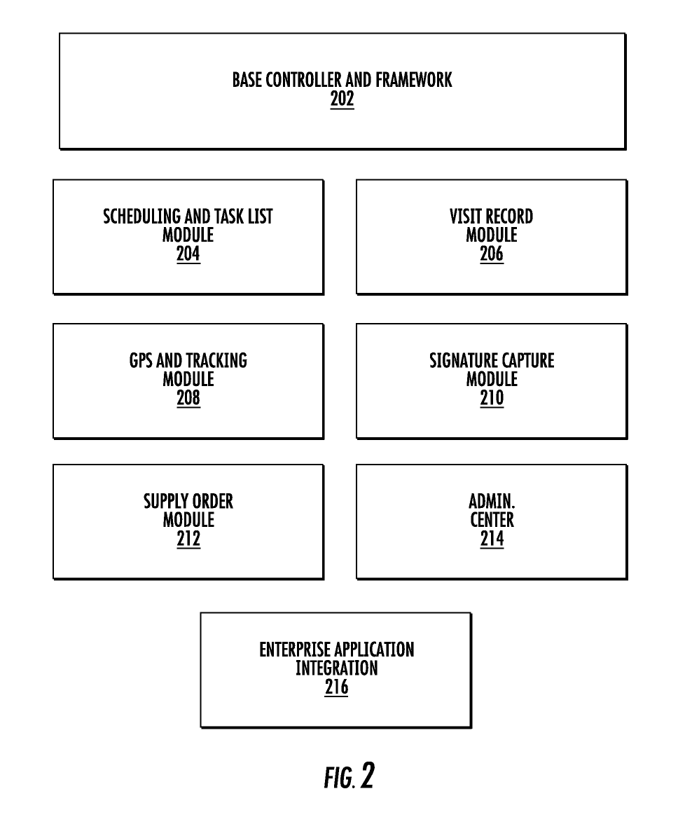

FIG. 2 is a simplified block diagram illustrating representative modules 200 that may be included in an embodiment of the present invention. The modules include an underlying base controller and mobile framework module 202 and a plurality of functional modules 204-216. Each of these modules will now be described in order. While all of the representative modules 200 may be included in certain embodiments of the present invention, some embodiments may be omitted in alternative embodiments, depending on the particular functionality to be provided by the MCM system.

Base and Mobile Framework

The base controller and mobile framework 202 is the foundation layer of the MCM system 100 and is what allows the other modules 204-216 to operate. Based on the framework 202, applications in the system 100 are designed and configured to provide optimal performance in the mobile home care and home health settings. For example, the framework includes, but is not limited to, components such as dynamically rendering data collection forms or fields on the mobile device 102; dynamically rendering applications from the provider network 104 to the mobile device 102; and managing data types, rules, validation, offline data storage, security, and data transmission between the mobile device 102 and the provider network 104. For example, dynamic rendering of data collection forms or fields on the mobile device 102 may include the appearance on the mobile device 102 of a particular electronic fillable form or field to be filled out by a CS during a Member visit.

Dynamic rendering of applications from the provider network 104 to the mobile device 102 allows application(s) on the mobile device 102 to be updated and/or supplemented without frequent recompilations. By specifying, through use of the provider network 104, client or company specific requirements, (such as graphical menus, layouts, widgets, and data) The MCM may be modified, updated and rendered on the fly. The server sends the actual application as well as the metadata concerning the visit-specific form.

Managing data types, rules, validation, offline data storage, security, and data transmission are other tasks that are preferably handled by the framework 202.

Offline data storage may be necessary in at least two cases: while the mobile device 102 is out of wireless data service coverage, so that the data needs to be stored until coverage is present again, and (2) when data has just been collected and entered into the mobile device 102, but not yet transmitted to the provider network 104. Such offline data storage is preferably in memory or some other storage medium that maintains its contents even if the device 102 is powered down.

Security may include at least two aspects. A first aspect is directed to assessing whether the possessor/user of the mobile device 102 is authorized to access the mobile device 102. This assessment could include requiring the user to enter a PIN (Personal Identification Number) or username and password, for example, when the mobile device 102 is turned on or a home care application is started up on the mobile device 102. This is to prevent an unauthorized user from accessing (1) applications pertaining to the system 100, and (2) offline data that may be stored on the mobile device 102. The second aspect is directed to protecting data as it is communicated across communication links 110/112. The second aspect may be addressed by encrypting the data and deleting offline data from the mobile device 102 once it has been sent to the provider network 104.

Scheduling Module

The scheduling and task list module 204 enables the provider and CS to dynamically create, publish (provide appropriate notification), and synchronize schedules and tasks bidirectionally in real-time, while CS are in the field. There are two aspects to these scheduling functions. First, as opposed to being only static, the scheduling module 204 allows a CS' schedule to change while the CS is in the field (e.g. conducting a visit at a Member's home). For example, while a CS is conducting a visit at a Member's home, the administrative staff of the provider might update the CS' schedule. A second aspect to the scheduling functions handled by the scheduling module 204 is its bidirectional nature. Workers in the field (e.g. CS) are able to set schedules according to predefined rules. For example, if this functionality is present and enabled, a CS might set the schedule for a follow up visit to a Member's home or update a task list.

In an example embodiment, the scheduling module 204 acts as a workforce management system that generates work schedules dynamically based on a plurality of worker (CS)-based variables, Member-based variables, or other variables. Example CS-based variables include (1) a CS' location, (2) a CS' expertise level, and/or (3) whether a CS has previously conducted a visit at a particular location. Example Member-based variables include (1) a Member's location, and/or (2) a Member's care plan or medical plan status (e.g. covered services/timing versus non-covered services/timing).

The aforementioned workforce management system preferably interfaces with the GPS tracking and travel management module 208 to obtain CS location information. Member information, such as location information, may be obtained from home office records (such as a Member database), for example. Dynamic generation of schedule information based on location information may be accomplished by selecting visits in order to minimize a travel-route cumulative distance, as determined by accessing maps databases, such as those offered by NAVTEQ or Tele Atlas NV, for example.

Visit Record Module

The visit record module 206 preferably comprises software applications resident on the mobile device 102 and at the provider network 104 (such as on the server computer 114) for electronically creating, storing, communicating, and monitoring information on Members, visits, tasks, care plans, and other home-care-related information. The visit record module 206 provides customizable task lists that may be downloaded in real-time to a CS' mobile device 102. Customization may include, for example, the ability to add tasks to a visit “on-the-fly,” such as throughout a particular Member's overall home care period. Such task list customization may be accomplished, for example by presenting a task list administrator with a user interface identifying a plurality of tasks that be selected, such as through check-boxes that the administrator may select.

When used in conjunction with the scheduling module 204 or a variation thereof, the visit record module 206 can be utilized to deliver the Member-specific, visit-specific task lists to the correct CS at the correct time and place (such as when the CS is arriving at the Member's home). When used in conjunction with the GPS module 208 (described below), the visit record module 206 may receive a notification that the CS' location is close to or the same as the Member's location, which can serve as a “transmit initiation” signal indicating that that particular Member's task list should be sent out to the CS at that location (as determined by the GPS module 208) (i.e. “pushed” by the provider network 104 to the mobile device 102). Alternatively, the task list for a particular Member may be transmitted at a particular time, as maintained by the scheduling module 204 (i.e. “pushed” by the provider network 104 to the mobile device 102).

In addition, the visit record module 206 helps to ensure that the visit record (the data entered by the CS into the fillable form or fields) matches the individualized task list. As a result, no extra tasks are performed (saving time and expense) and no tasks are omitted without reason (promoting the Member's well-being and saving extra expenses associated with extra Member visits to complete omitted tasks). This also helps to ensure compliance with organizations and packages requiring standardized formats, such as those reporting records required by Medicare and other reimbursing organizations. Service codes and billing exceptions and required records (e.g. HHA records) can be generated automatically.

Another function that can be performed by the visit record module 206 is to validate data entered by the CS. Validation is basically comparing the collected (entered) data with built-in user-defined business intelligence and/or rules that can be specified by a user, such as the provider. Thus, while the data may technically be the correct type of data (e.g. an integer) as called for by a particular rule, it may still be acted upon by the business intelligence to generate an alarm condition (e.g. call nurse). Rules and business intelligence can be communicated by metadata, as discussed above with reference to the base and mobile framework 202.

Finally, the visit record module 206 can be used to assign or attach multiple task lists to a single Member. In a sophisticated home care system, a single Member may have more than one CS.

GPS Tracking and Travel Management Module

The GPS tracking and travel management module (“GPS module”) 208 can be included in various embodiments of the invention to assist in tracking CS, presenting actual driving mileage traveled by a CS along with a shortest route indication and shortest mileage, tracking actual visit times, and alerting missing or delayed visits as exceptions. In order to offer this functionality, the mobile device 102 needs to be equipped with a mechanism for determining its current location, such as a GPS receiver. Many mobile devices manufactured today and in recent years include a GPS receiver in them, which can be used for this purpose. By transmitting the current location of the mobile device 102 (based on an output from the GPS receiver) to the provider network 104, the provider network 104 will have information pertaining to the current location of CS in the field, assuming each CS has an associated mobile device 102.

To provide the home office with information for tracking CS, GPS position updates could be periodic, such as every 10 seconds, or based on change in location, such as whenever the GPS coordinates indicate a change in location of more than one kilometer, for example. Other location updating schemes could also be used and are intended to be within the scope of the present invention. In a preferred embodiment, the location-updating period may depend on the schedule maintained by the scheduling module 204, so that if a CS is at lunch or on vacation, no GPS updates are transmitted.

An advantage of tracking location of mobile CS is that actual driving mileage can be obtained from the transmitted location information. This can help to lessen or eliminate the need for CS to manually record their mileage and can help to reduce mileage reimbursement costs for a home care entity. According to one embodiment, the system 100 can also determine a shortest path by including an application on the server computer 114 that can access a map database (such as one produced by NAVTEQ or Tele Atlas NV) that associates roads and other geographic features with coordinates, such as the latitude-longitude information included in a GPS signal. By utilizing known routing software to find a shortest path between an origin and a destination, the server computer 114 can determine the shortest path and compare it, if desired, to the path taken by the CS.

Another advantage provided by tracking CS location is the ability to identify potential problems, such as when a CS is likely to be late for a scheduled visit, based on the current location of the CS (as determined from the location of the mobile device 102), the distance to the Member's location, and possibly other information, such as the average or maximum posted speeds for the roads on the shortest path and/or traffic information from a traffic provider. Another advantage provided by tracking CS location is the potential for detecting that a scheduled event never occurred, such as due to the CS forgetting or misreading a schedule, for example. This can, in turn, improve customer service should the Member contact the home office regarding the missed visit and help in the prevention of abuse or fraud by a CS.

Finally, the GPS and travel management module 208 can help home care staff plan optimized Member visit times depending on the optimized route planning. The GPS and travel management module 208 can intelligently calculate the most economic visit sequence based on a combination of factors including, without limitation, Member location, visit duration, pre-scheduled Members, visit starting location and places required to be visited during the day. In this embodiment, the GPS tracking and travel management module 208 preferably integrates with the workforce management system described above, with respect to the CS scheduling module 204.

Supply Order Fulfillment Module

The supply order fulfillment module 212 addresses a common inefficiency observed in typical, traditional home care practices—ordering supplies needed in the field. This module enables a CS to place supply order requests from his or her mobile device 102 at the point of need (the Member's home or other location). The supply order requests are transmitted to the provider network 104, where they can be aggregated at an application on the server computer 114 for order fulfillment or transmittal to a third party.

Signature Capture Module

The signature capture module 210 works with the visit records module 206 and transmits captured data in the form of a Member's electronic signature to the provider network 104 for retention and verification that a CS performed assigned tasks and visited. This, in turn, can be integrated with third party systems theough the administrative center module 216 and the enterprise application integration module 214.

Administrative Center Module

The administrative center module 214 is preferably a portal on the server computer 114 that allows a provider and/or office staff to manage a the MCM system 100. In an example embodiment, the portal is a web-based portal offering anytime/anywhere information access, to that the business can be managed virtually. This promotes telecommuting and will generally tend to reduce timelines associated with scheduling, approving, and submitting invoices for payment. This, in turn, can shorten accounts-receivables timelines, which will typically be a financial benefit for the provider. While the system 100 is pictured as having a single server computer 114 to act as a web portal, there may instead be multiple server computers 114 at a single location (for load balancing and redundancy, for example), or there may alternatively be different server computers 114 affiliated with regional or local provider networks and having different web addresses from one another.

One function support by the administrative center module 214 is managing users of the system 100. A provider and/or office staff person can add, delete, and/or edit users of the system, such as CS and others. In addition, other properties associated with each user may be defined, such as roles, permission levels, and authority hierarchies, for example. The administrative center module 214 residing on the server computer 114 provides for numerous roles that assign different rights to users communicating with the server computer 114.

A second function relates to tasks that may be performed by a CS for a particular function. While the visit record module 206 is the primary module for ensuring tasks are completed, the administrative center module 214 can serve as the interface for selecting, defining, and modifying tasks to be performed. Correspondence between tasks in the system 100 and tasks supported by outside reimbursement agencies can also be determined at the administrative center module 214.

A scheduled visit is a visit that has one or more tasks associated with it and that has been scheduled to be performed by a CS. An office administrator (admin) or an appropriate delegate may be responsible for setting the daily tasks for the CS. This includes creating, reviewing, and editing task lists that the CS is to perform during a visit to a Member's home. The admin prepares the Member visits, for example, by using the administrative center module 214 on the server computer 114. After a Member is entered (or already exists) on the server computer 114, the admin creates or edits an individualized Member task list by checking which tasks an agent is to perform during a visit. The admin saves Member information for storage at the server computer 114. In one example, the admin adds or edits Member information for database storage associated with the server computer 114. Information such as the Member's name, address, latitude-longitude information, Member medical record number(s), location (servicing home-care office), and a corresponding task list may be entered manually. Alternatively, the administrative center module 214 provides a method to import Member information using one or more conventional techniques. After the appropriate Member information is entered in the administrative center module 214, the admin creates or edits a Member task list by checking which tasks an agent is to perform during one or more visits. The admin saves the Member information for storage in memory.

An open visit is a visit that is being performed by a caregiver or other person in the field. Visits can thus be monitored as they happen. CS perform visits using the mobile devices 102. The admin is able to view visits that have been started by a CS in real time. The visit can also be deleted should the visit be abandoned accidentally. In example embodiments, the server computer 114 can display a visit in at least four different views, according to one embodiment: open, pending, approved, and history.

Enterprise Application Integration Module

The enterprise application integration module 216 may be included in the system 100 if the system 100 will be integrated with applications from third parties. The enterprise application integration module 216 includes application components that are designed to communicate with other home care systems and has features to support multiple communication protocols, including, without limitation, HTTP, FTP, and Secure FTP. Possible data structures that may be embodied in such communication protocols include HL7, XML, CSV, and other formats. The module is flexible to support real-time communication and file batch communication. The enterprise application integration module 216 also includes a data mapping utility that maps incoming data messages from the third party format into its own data format that the database server 120 supports.

For example, the billing/accounting system 122 shown in FIG. 1 may be a third-party application. The enterprise application integration module 216 would allow that third-party application to integrate and interoperate with applications on the server computer 114 and/or the database server 120, for example. This may enable administrators and/or other home office staff to view integrated and complementary views of financial and billing information. Other third-party applications that might be partly or entirely integrated into the system 100 using the enterprise application integration module 216 are a scheduling and/or payroll system, a clinical medicine database application, Medicare compliance applications, and others. The information exchanged between the enterprise application integration module 216 and third-party applications may be exchanged in real-time or near real-time, for example.

Mobile Care Computing Application

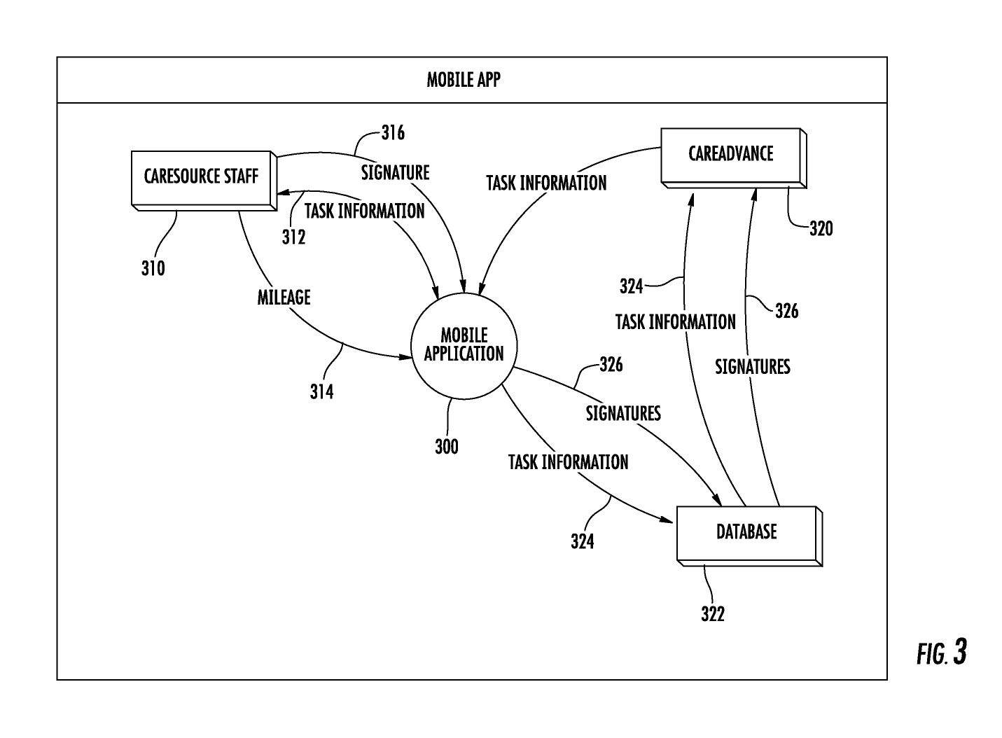

Referring now to FIGS. 3-7, the MCM of the present invention is illustrated and may be deployed to a mobile transmission device that is communicably linked to a provider network (e.g., Care Advance). Referring specifically to FIG. 3, a schematic diagram of an exemplary MCM is shown. As shown, an MCM 300 is provided and is communicably and bidirectionally connected to a mobile device 310 deployed to a CS such that data in the form of tasks 312, mileage 314 and Member verifications 316 may be exchanged. In addition, the MCM 300 may be communicably and bidirectionally connected to a provider network (Care Advance) 320 and a database 322 such that member and encounter information may be exchanged. In example embodiments, the database 322 is connected directly to the provider network 320 and the exchanged information includes tasks 324 and captured electronic Member signatures 326. Advantageously, the use of the MCM application 300 and its associated architecture allows for a simpler implementation and deployment structure than traditional mobile applications.

(a) Architectural Design

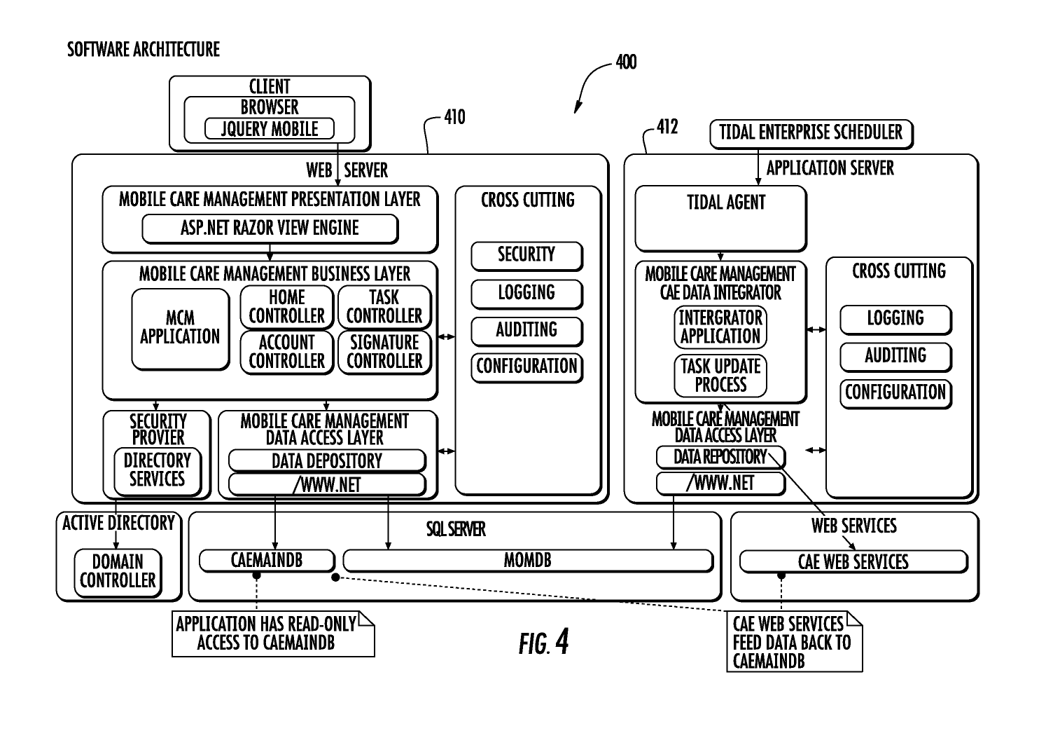

Referring now to FIG. 4, a scghematic diagram of an example software architecture 400 is shown. As shown and in example embodiments, the MCM 300 is split into two (2) separate systems, one being the main web application 410 accessible by the mobile transmission device and the other being a “back end” or server side 412 process for synchronizing task updates into the provider network.

In example embodiments, the MCM 300 will directly access the Care Advance database 322 when synchronizing tasks to its own database; the synchronization process will occur during a CS login event and as needed during interaction with the system. If the Care Advance system 320 is down due to infrastructure or connectivity issues, the system will rely on its own task database, possibly indicating to the CS that it is in a disconnected state.

A MCM authentication is performed using direct access to Active Directory, this will provide a single sign-on solution. Authorization will be performed using Active Directory groups mapped via configuration to application specific roles and features.

A Data Integrator process will be managed as a Tidal Job and will run a on a frequent scheduled basis. The process will update care advance tasks using the Care Advance web services API. Tasks in the completed status will have their information copied to the Care Advance system 320 using the web services API.

(b) External Relationships

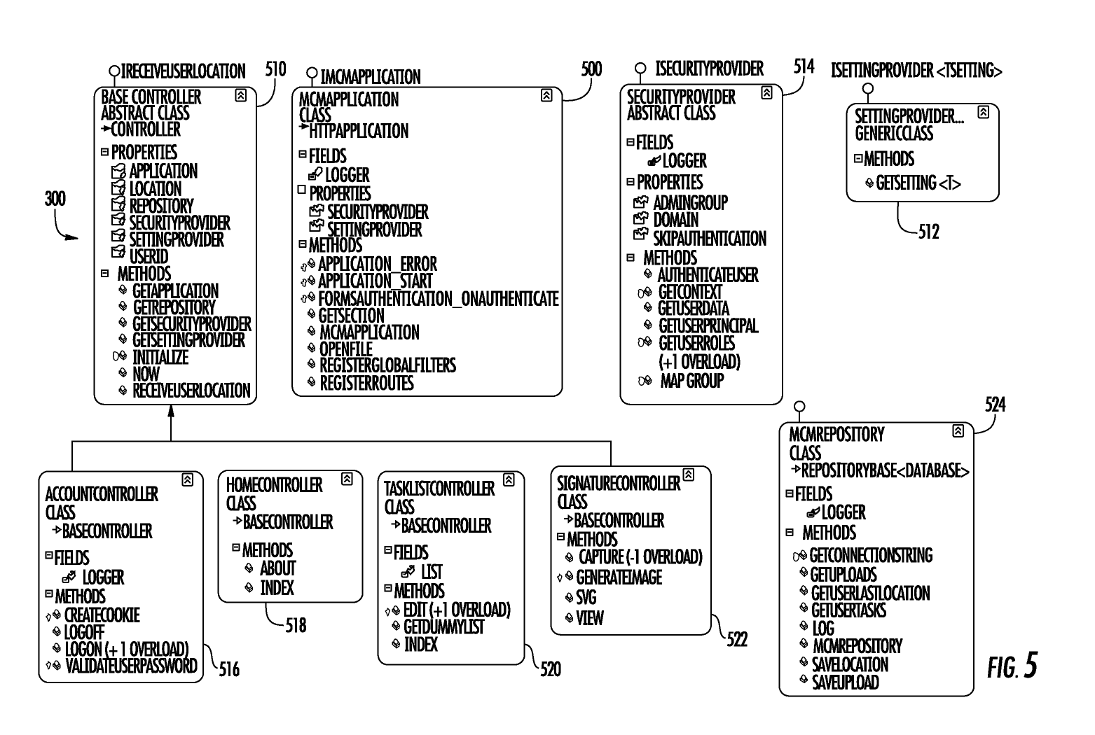

Referring now to FIG. 5, various features or classes which comprise the system 100 of the present invention are illustrated. As shown, the MCM 300 may directly access the Care Advance Database 322 using Ado.net SQL native client. Updates are performed by a “backend” application that uses the Care Advance Web Services API. The classes may include the following:

MCMApplication 500—This class is the main Asp.net web application instance. This class also doubles as the context object via the IMCM Application interface.

BaseController 510—This abstract class is the base class for all controller classes within the application. It handles delegation between derived controllers and the MCMApplication 500. Any globally used functionality is added to this class.

SettingsProvider 512—This class provides a structured interface for retrieving configuration settings for the application and Controllers. The current implementation supports reading settings from the MCM 300 configuration file.

SecurityProvider 514—This class provides an interface for authenticating users, and determining the users list of authorized application roles. The current implementation interfaces with Active Directory for authenticating users and mapping Active Directory groups to application roles.

AccountController 516—This class handles the LogOn and LogOff events, delegating security to the SecurityProvider.

HomeController 518—This controller class handles the Index action that is used as the entry point of the application.

TaskListController 520—This controller class handles all actions with respect to the task list.

SignatureController 522—This controller class handles all actions related to capturing and displaying signatures.

MCMRepository 524—This class is the single data layer of the application. It handles all database operations.

(c) Data Description

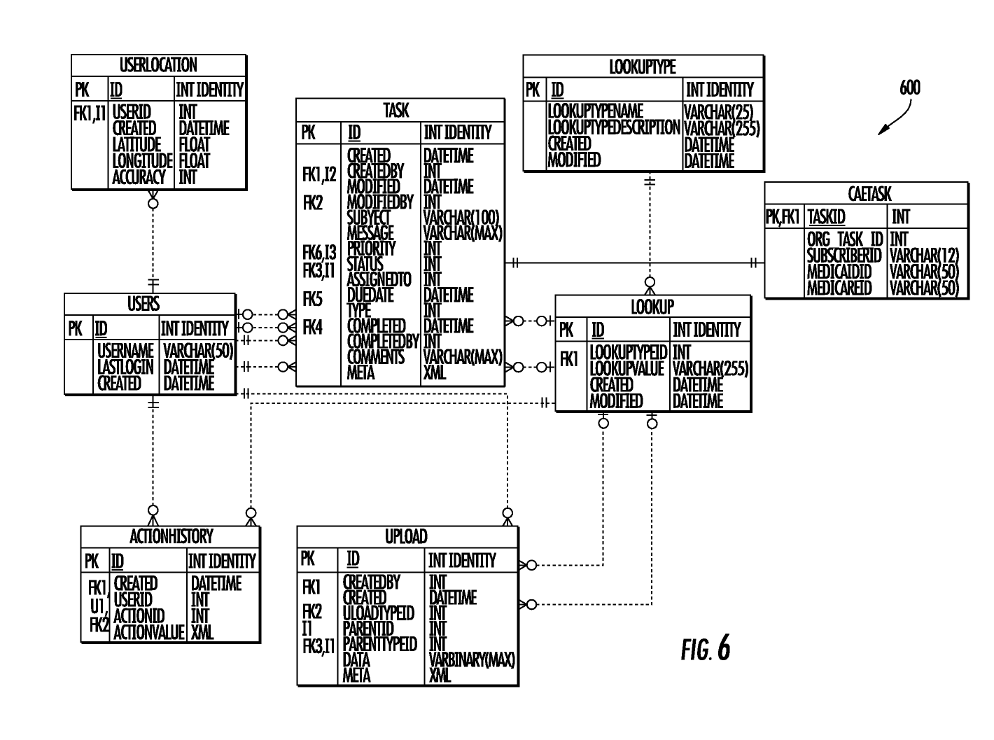

In exemplary embodiments, the data design 600 of the present invention is illustrated in FIG. 6 and includes: MCMDB—A custom Sql Server 2008 database that is used for managing and tracking tasks within the MCM system. In addition user locations, and user action auditing events are captured for reporting purposes.

CAEMAINDB—The main Care Advance Enterprise database. This database is accessed by both the Web and Integration applications. No custom objects are stored in the database by the MCM system.

(A) MCMDB Description

(i) Audit Tables

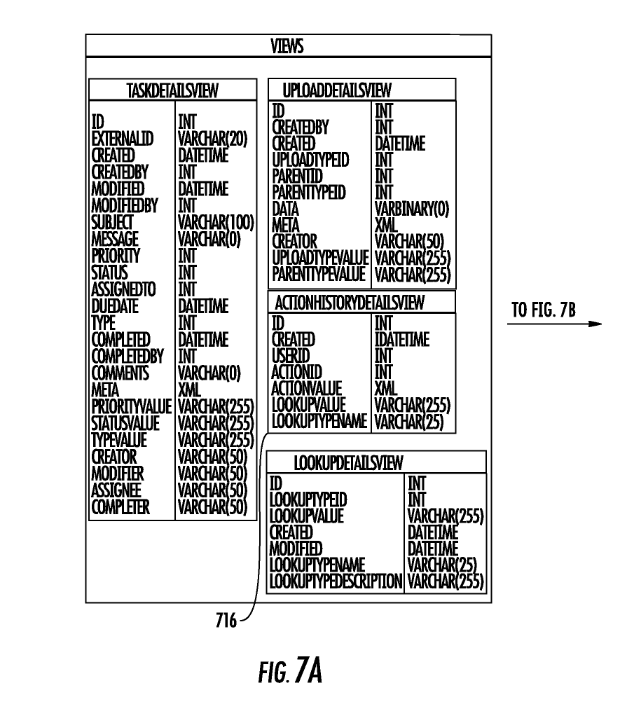

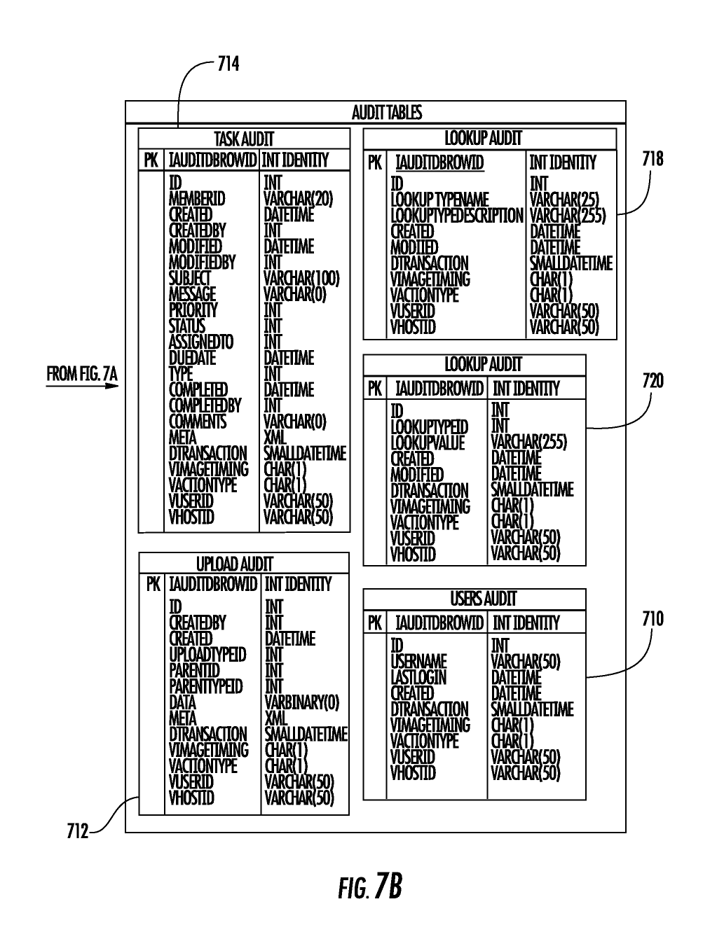

Referring now to FIGS. 7A and 7B, a diagram of view and audit tables 700 used in accordance with an exemplary embodiment of the present invention is shown. As shown, the view and audit tables 700 may include:

Users 710: The users table 710 is used for translating logged in user's (CS) username to the user id used within the database. The table 710 holds basic information about the CS that can be used for reporting but it is not used for Authentication.

Upload 712: The upload table 712 holds binary information such as the signature images generated by the system 100. The Meta field is an XML column that holds any ancillary information captured around the upload, in the case of the signature it is the raw input points captured during the signature process. Additional data that could be stored included file MIME types, and with or height attributes.

Task 714: The task table 714 is the primary table of the system 100 it contains the CS' tasks. Tasks are controlled by the assigned to status and due date. Task related non-editable data is stored in the meta xml column, such as Member demographics.

CAETask (not shown): This table stores the link information between MCM tasks and Care Advance.

UserLocation (not shown): The user location table stores the history of a user's geo location while interacting with the application.

ActionHistory 716: The action history table 716 stores an audit record of application level actions. Examples of actions stored are: LogOn, LogOff, Task View, Task Complete, and Signature Capture. This table 716 can be used for reporting user activity to management.

LookupType 718: This table 718 stores the classification of lookup values.

Lookup 720: This table 720 stores the possible values for lookup based task fields.

(d) Overview of User Interface

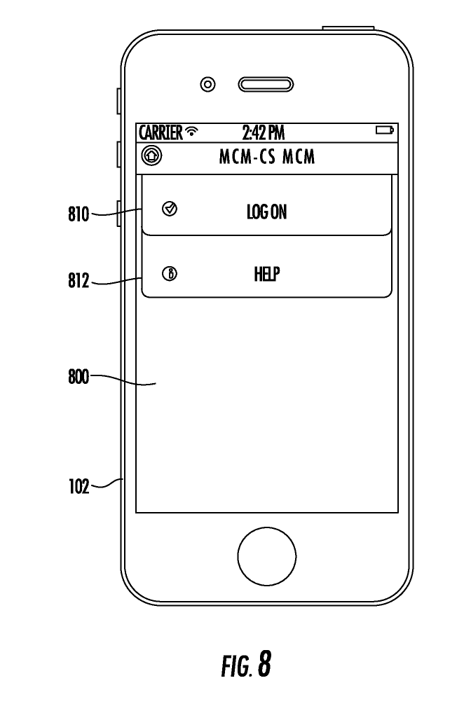

Due to a limited screen size and resolution the amount of information that can be displayed at once should be considered. The mobile web application of the present invention utilizes various screens to increase the CS experience (see, FIGS. 8-29). CS are also limited to using on screen keyboards so the use of text input is kept to a minimum by providing a display that accepts touch screen input values and list options. CS navigation is also displayed as a list and be available at the footer of each screen.

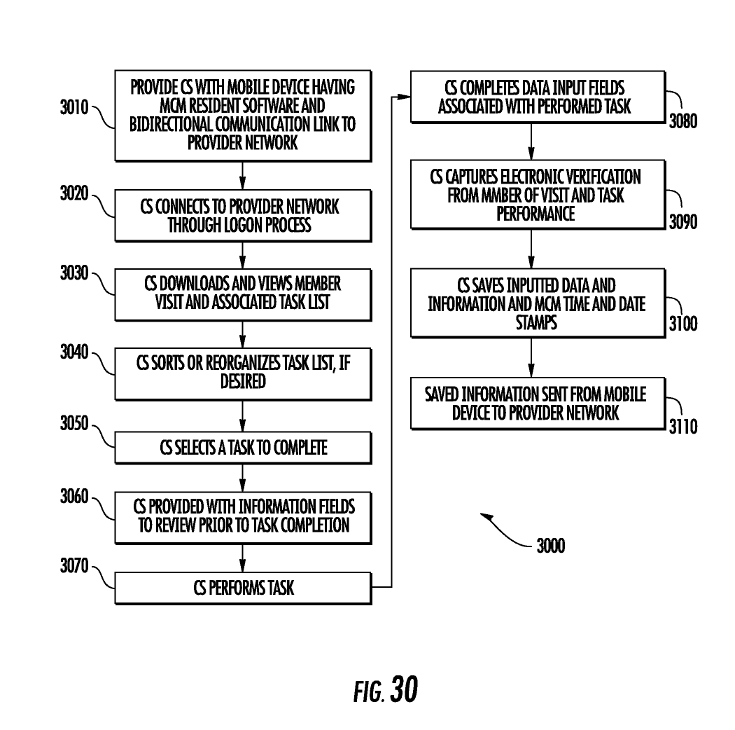

Referring now to FIG. 30 and in exemplary embodiments, the method 3000 of the present invention includes a CS being provided with a mobile transmission device (Step 3010) that is in signal communication with a provider network via a mobile web application. It will be appreciated by those skilled in the art that the mobile transmission device may be any mobile device configured to connect to the Internet. In example embodiments, the mobile device is a touch screen type device configured to have data and other information input into the devices memory via tactile input of the CS. The CS connects to the provider network's server/database via the mobile web application (Step 3020) and downloads and views a task list (Step 3030). In example embodiments, the task list is organized by date ranges, with the most recent task situated at the top of the list. The CS may then sort or reorganize the task list by a variety of factors, including the urgency/priority, the date/time, or the member (Step 3040). Thereafter, the CS will select a task to complete (Step 3050).

Upon selecting a task, the CS will be provided with information fields for review (Step 3060). The information fields may include: the member name, the date/time, the priority, a subject line and notes. In example embodiments, the member name information field may include information such as the member ID, the member gender, the member age, the member DOB, and/or the member contact information.

Subsequent to reviewing the information fields for the selected task the CS will perform the task (Step 3070) by selecting activities associated with the task from a predefined list. The CS may then input information or data into required fields (Step 3080). In example embodiments, the CS may also select a place of contact from a list. The CS may then enter notes or comments containing details of the actions performed. The CS may also enter the mileage associated with the task in a predefined field. The CS may also capture the signature of the member (Step 3090). The CS may save the data and information to the device (Step 3100). At the time of the save function, a location and time feature will correspondingly capture and record the location and time of the save.

The saved information is sent to the provider network to populate progress notes (Step 3110). Once the information is populated to the provider server, the task will be removed from the task list. In example embodiments, a notice may be sent to the CS via a text message or an e-mail which may be accessed via the mobile device. In additional embodiments, the task list may be periodically updated with new tasks. In such instances, the CS may be notified of the new addition, or the task list may be automatically updated and sorted based upon the urgency/priority of the task.

FIGS. 8-29 illustrates representative screen shots for the MCM 300 and modules described above for the mobile device 102 and the provider network 104. These screen shots are merely examples, and other alternative implementations are also intended to be included within the scope of various embodiments of the invention.

FIG. 8 shows pictorial representations of a display screen for a mobile device 102, showing a non-authenticated home screen 800 for a mobile care management application, according to one embodiment of the invention. As shown, CS or user is not logged into the system and a Logon button 810 and Help button 812 is displayed.

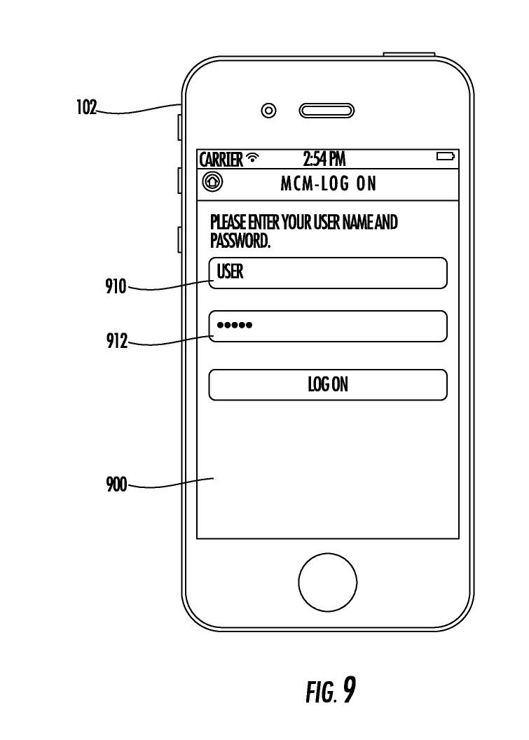

FIG. 9 shows pictorial representations of a display screen for a mobile device 102, showing a logon screen 900, according to one embodiment of the invention. As shown, the CS may input data in an attempt to log into the MCM system by inputting relevant information such as a user name and a password into respective username and password fields 910, 912.

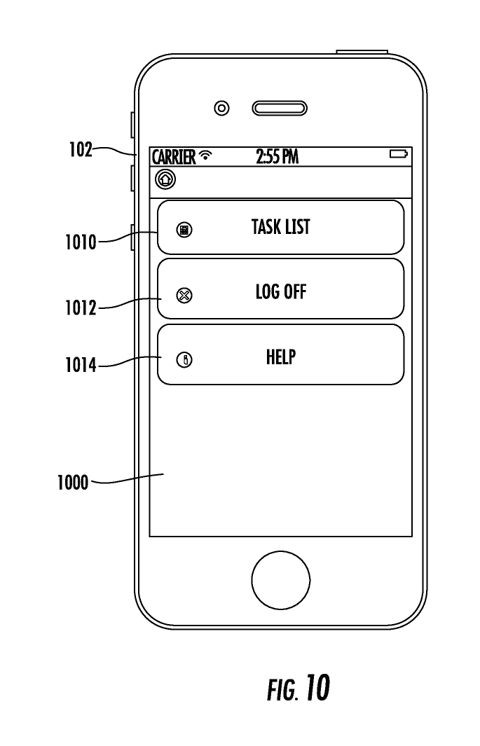

FIG. 10 shows pictorial representations of a display screen for a mobile device 102, showing an authenticated user home page screen 1000, according to one embodiment of the invention. As shown, once the CS is logged into the MCM system, new icons are displayed for access, including but not limited to a Task list button 1010, a log off button 1012 and a help button 1014.

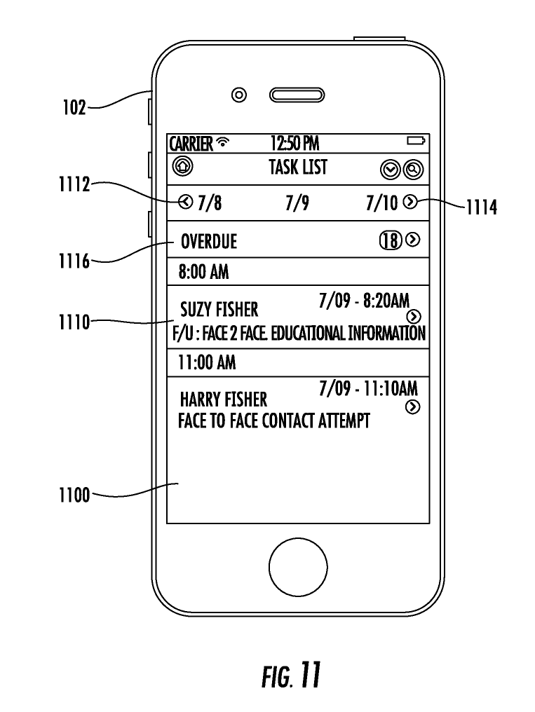

FIG. 11 shows pictorial representations of a display screen for a mobile device 102, showing a task list screen 1100, according to one embodiment of the invention. As shown, a list of assigned tasks 1110 are displayed for the CS. Left and right navigation buttons 1112, 1114 are provided and permit navigation between the next/previous day, week, month and year. In addition, overdue tasks 1116 are displayed as a link to an overdue task list.

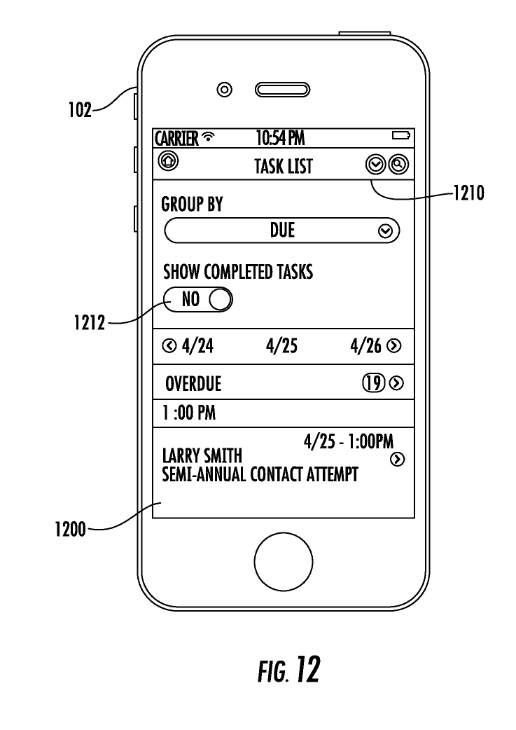

FIG. 12 shows pictorial representations of a display screen for a mobile device 102, showing a task list options screen 1200, according to one embodiment of the invention. As shown, task list display options are displayed using a down arrow icon 1210 from the top of the menu bar 1214. The options area permits edits to grouping options. Further, an option is displayed 1212 which shows completed tasks of the task in view.

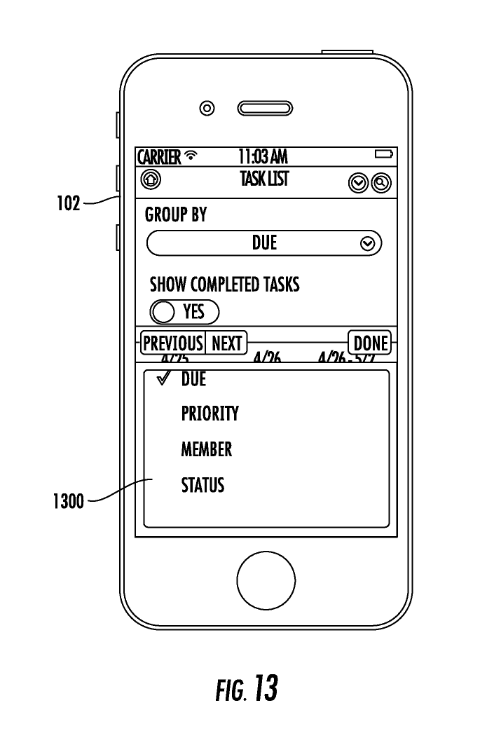

FIG. 13 shows pictorial representations of a display screen for a mobile device 102, showing a task list options by group values screen 1300, according to one embodiment of the invention.

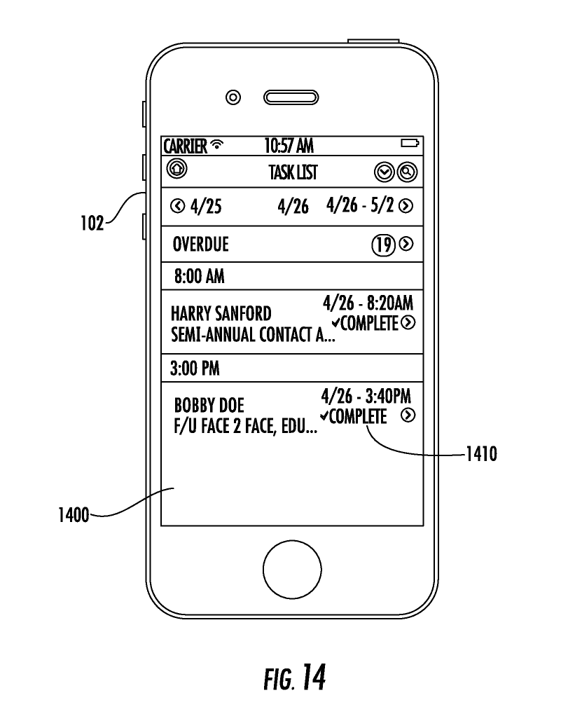

FIG. 14 shows pictorial representations of a display screen for a mobile device 102, showing a completed tasks screen 1400, according to one embodiment of the invention. As shown, completed tasks are displayed with a check mark and text 1410.

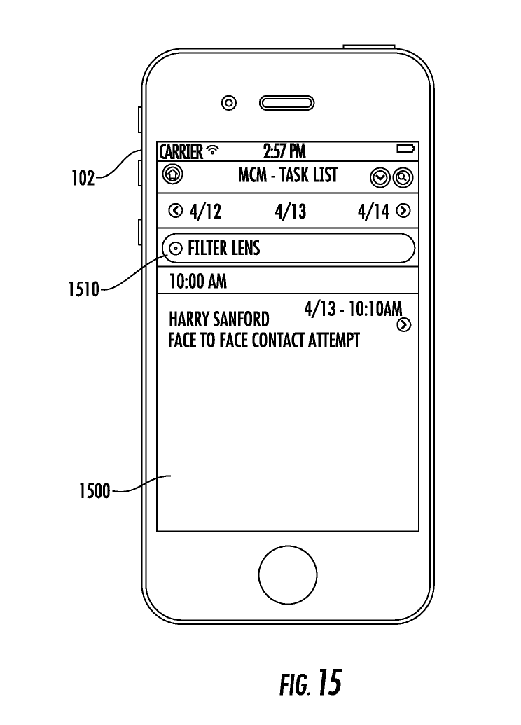

FIG. 15 shows pictorial representations of a display screen for a mobile device 102, showing a task filter screen 1500, according to one embodiment of the invention. As shown, the CS is permitted to filter the displayed tasks by inputting keywords or other data into an input field 1510.

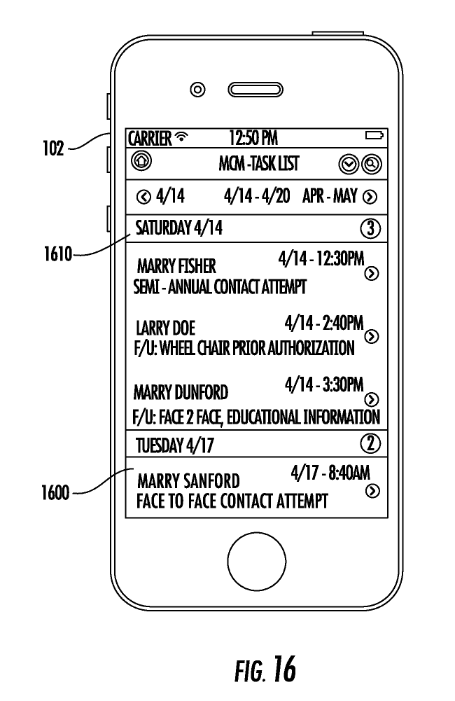

FIG. 16 shows pictorial representations of a display screen for a mobile device 102, showing a task list one week view screen 1600, according to one embodiment of the invention. As shown, tasks may be displayed by selected groupings, such as by date ranges 1610.

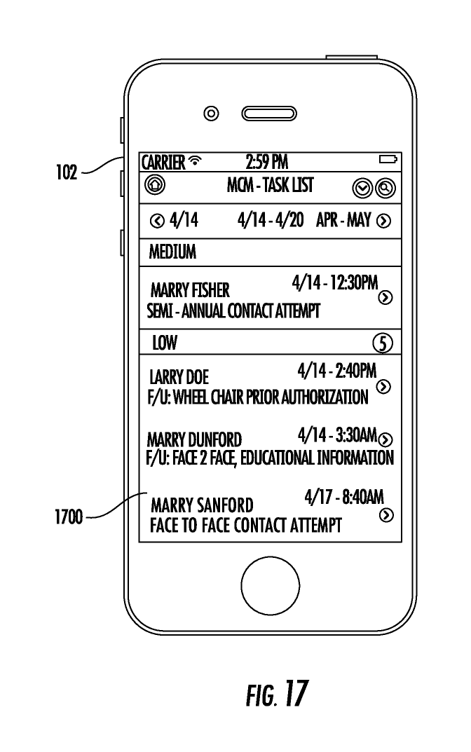

FIG. 17 shows pictorial representations of a display screen for a mobile device 102, showing a task list ordered by priority screen 1700, according to one embodiment of the invention.

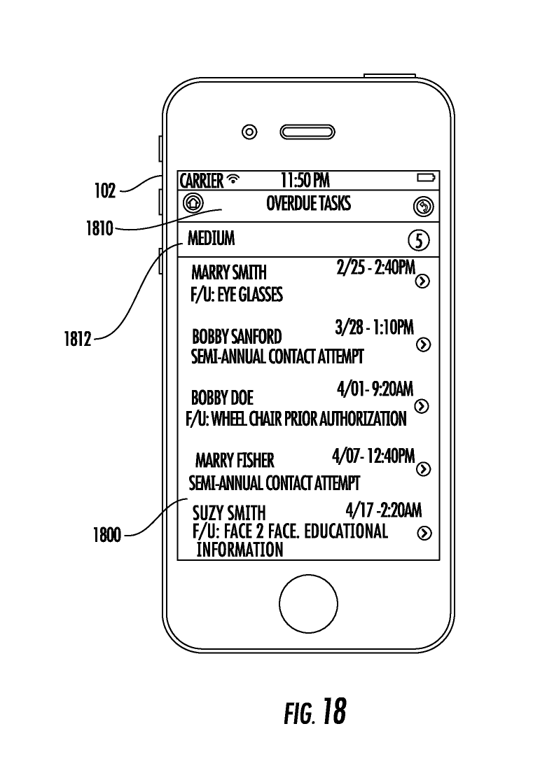

FIG. 18 shows pictorial representations of a display screen for a mobile device 102, showing an overdue tasks screen 1800, according to one embodiment of the invention. As shown, overdue tasks are displayed after the CS selects an overdue notification link from a previous task list screen 1810. Also, as shown, overdue tasks are grouped by priority 1812.

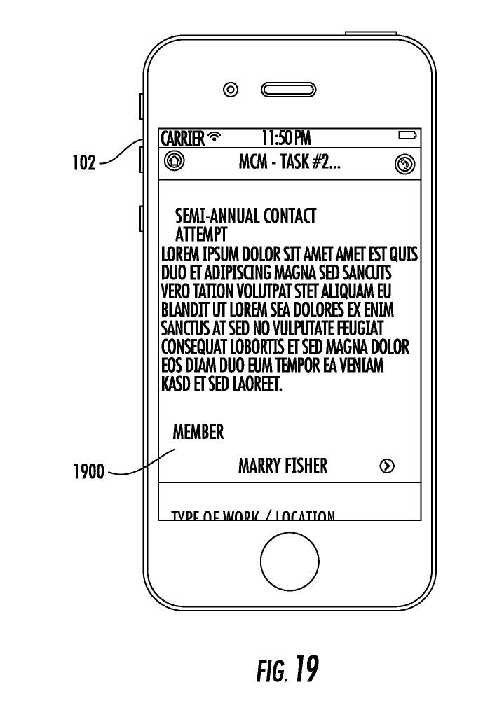

FIG. 19 shows pictorial representations of a display screen for a mobile device 102, showing a task completion screen 1900, according to one embodiment of the invention.

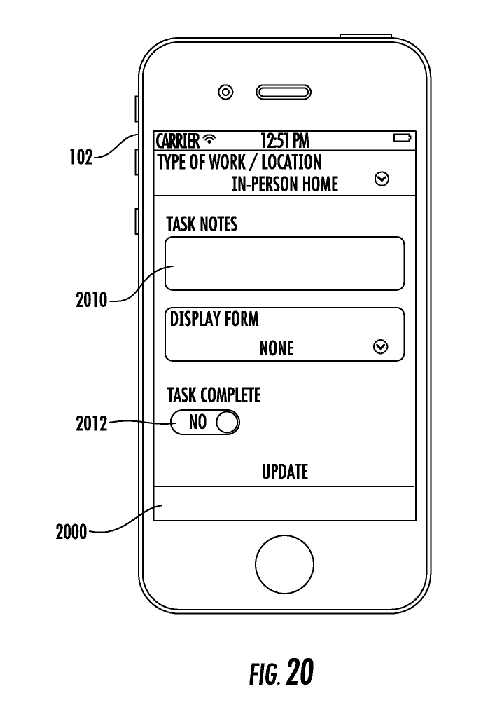

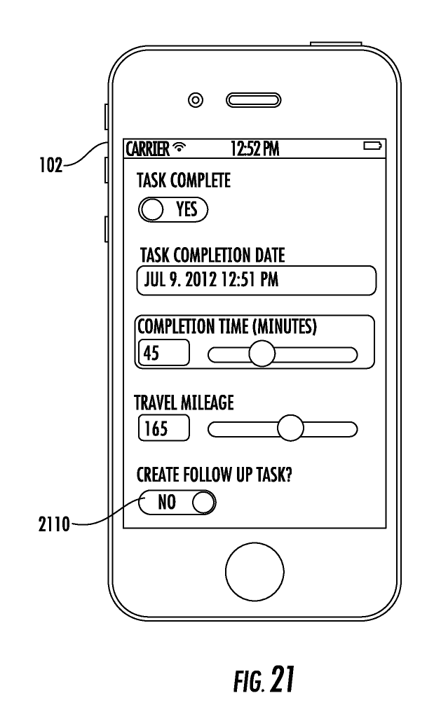

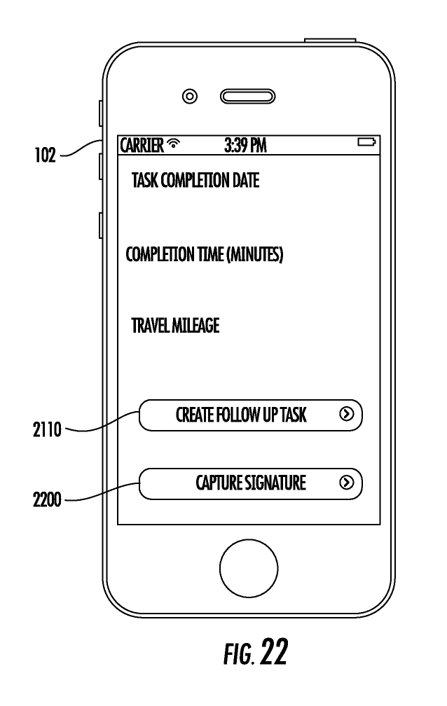

FIG. 20 shows pictorial representations of a display screen for a mobile device 102, showing a task complete screen 2000, according to one embodiment of the invention. As shown, once a CS completes a task he/she may input relevant information into an input field 2010, by touching, tapping or otherwise manipulating a task complete slider from one notification to another 2012. Also shown, a CS may update tasks multiple times before marking the task complete by inputting data into an input field. Once a task is marked as complete by a CS, the task completion fields are displayed (FIG. 21). An option for creating follow up tasks is displayed wherein data may be inputted into an input field 2110. Once the task is complete, information relative to the task may be viewed, but not, edited. Finally and as best shown in FIG. 22, a capture signature link is provided which may be selected by the CS.

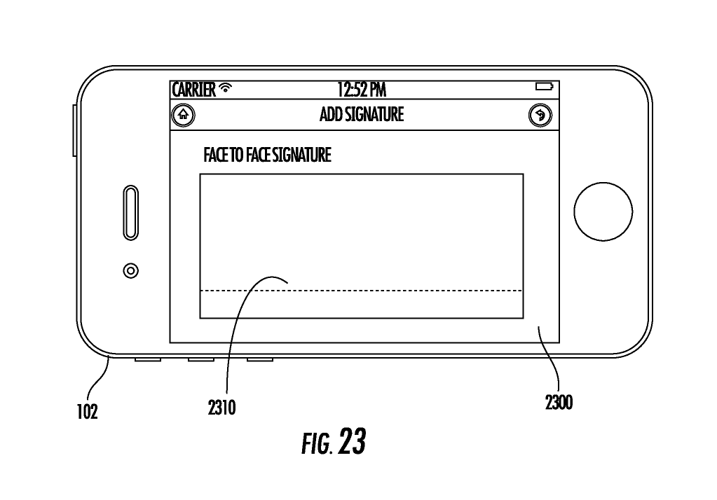

FIG. 23 shows pictorial representations of a display screen for a mobile device 102, showing a signature capture screen 2300, according to one embodiment of the invention. As shown, the signature capture screen 2300 may be accessed from the task completed screen. A signature verification or attestation input field 2310 is provided wherein a Member may input a signature or other identifying data.

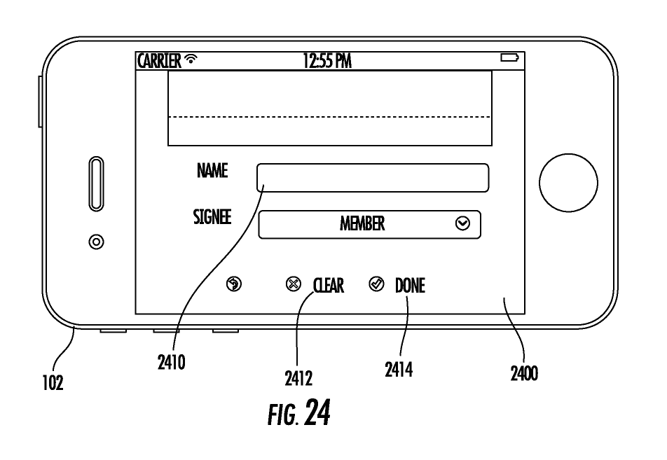

FIG. 24 shows pictorial representations of a display screen for a mobile device 102, showing a continued signature capture screen 2400, according to one embodiment of the invention. As shown, once the Member inputs the identifying indicia into the relevant input field 2310, the CS may input the signatory's name into a name input field 2410. Icons or buttons are provided for clearing the signature 2412 and/or completing the task 2414.

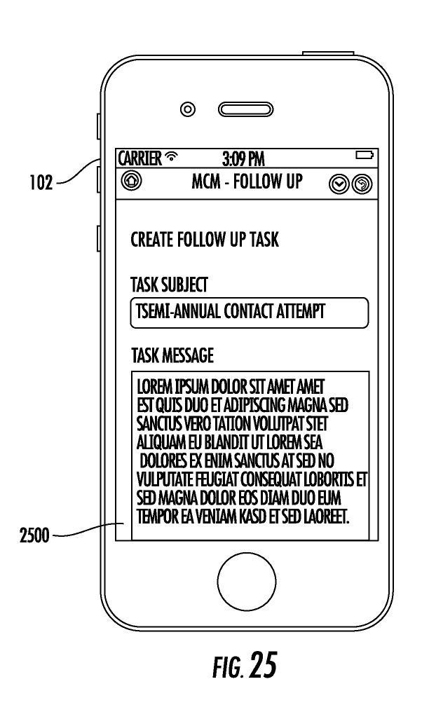

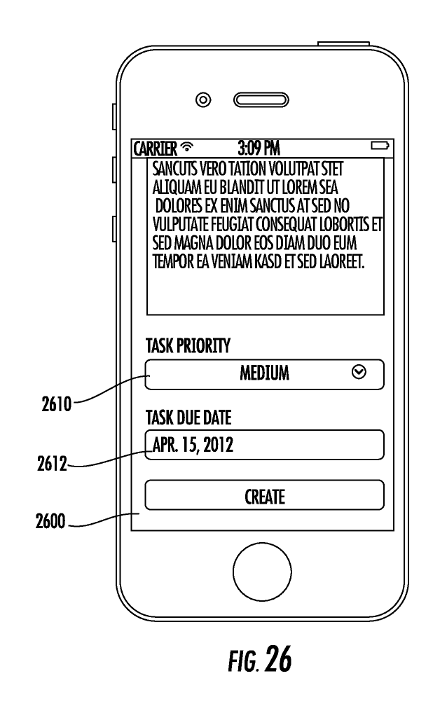

FIG. 25 shows pictorial representations of a display screen for a mobile device 102, showing a create follow up task screen 2500, according to one embodiment of the invention. As shown, a CS may modify task subject and message, copied from original task notification. As best shown in FIG. 26, once a follow up task is created a new display screen 2600 is presented wherein the CS may assign a priority level 2610 to the follow up task and a due date 2612.

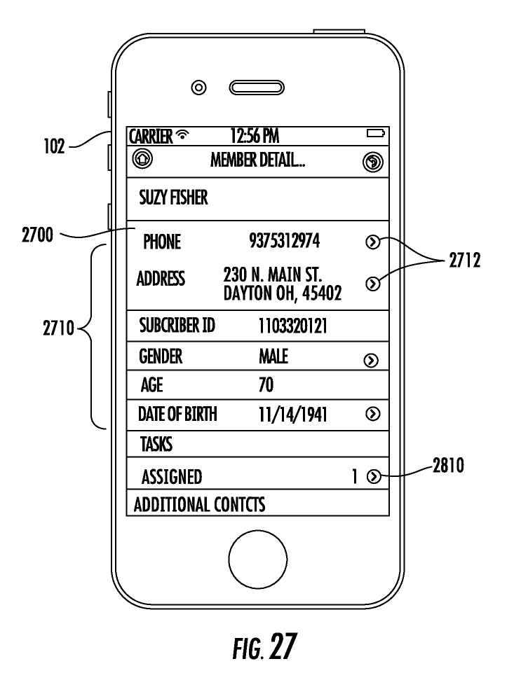

FIG. 27 shows pictorial representations of a display screen for a mobile device 102, showing a Member information screen 2700, according to one embodiment of the invention. As shown, the Member's demographic information 2710 is provided. The phone number and address are selectable links 2712 and can activate native device functionality such as calling or mapping. In addition, the number of open tasks associated with the Member is provided.

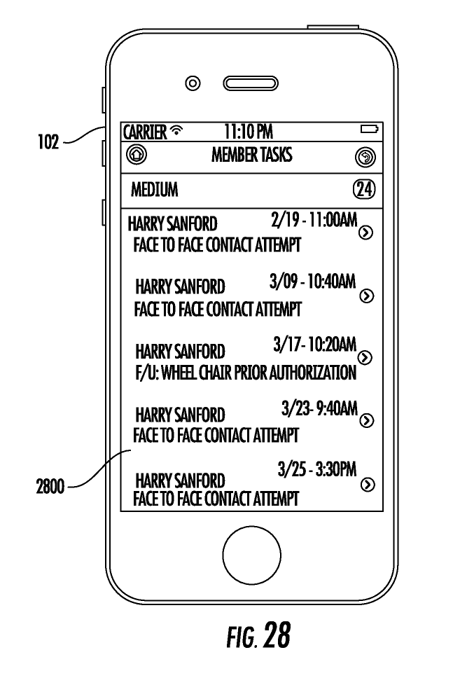

FIG. 28 shows pictorial representations of a display screen for a mobile device 102, showing a Member tasks screen 2800, according to one embodiment of the invention. As shown, by selecting the “Assigned” task button 2810 from the previous screen, all tasks relative to the member may be displayed by priority.

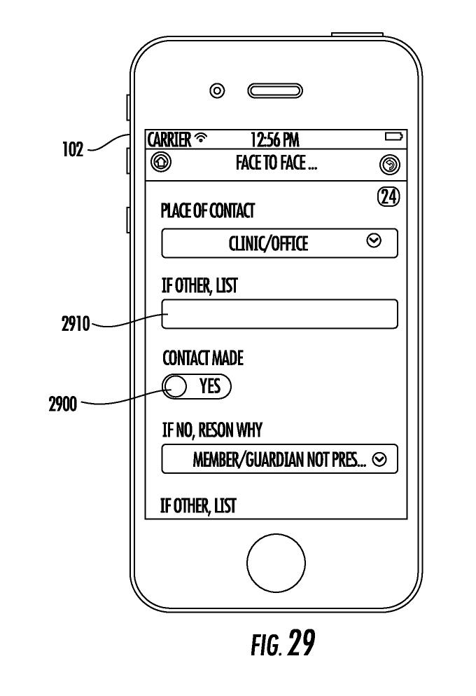

FIG. 29 shows pictorial representations of a display screen for a mobile device 102, showing a contact forms screen 2900, according to one embodiment of the invention. As shown, the CS may complete contact forms associated with a designated task by inputting information into an input field 2910. Form values are captured and transmitted to the provider network 104 so system wide updates may be made.

As will be appreciated by one skilled in the art, embodiments and aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages such as those listed herein above or those including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network such as those previously identified hereinabove.

Aspects and embodiments of the present disclosure are described above with reference to illustrations and/or block diagrams of methods, apparatus (systems) and computer program products according to embodiments of the disclosure. It will be understood that each illustration and/or block diagrams, and combinations thereof, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the illustrations and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the illustrations and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the illustrations and/or block diagram block or blocks.

The illustrations and block diagrams in the Figures illustrate the architecture, functionality and operation of possible implementations of systems, methods and computer program products according to various embodiments of the present disclosure. In this regard, each illustration or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or illustration, and combinations of blocks in the block diagrams and/or illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, it will be understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

The embodiments described above provide advantages over conventional systems and methods. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Furthermore, the foregoing description of the preferred embodiments of the invention and best mode for practicing the invention are provided for the purpose of illustration only and not for the purpose of limitation—the invention being defined by the claims.

What is claimed:

1. A system for creating, storing and communicating information associated with a remote encounter between a case manager and a member of a mobile care network, comprising:
at least one application module resident on at least one mobile transmission device having a display and being configured to bidirectionally communicate with a network server via the communication network;
a database communicably linked with the network server and accessible via the communication network by the at least one mobile transmission unit
wherein the at least one application module is configured for rendering on the display member information and task assignments having at least one data input field, capturing data input, and transmitting to the network server or the database the inputted data.

2. The system of claim 1, wherein the task assignments may be changed by a task administrator via a user interface which presents a plurality of tasks that may be selected.

3. The system of claim 2, wherein the plurality of tasks may be selected by having the task administrator activate a check box through the user interface.

4. The system of claim 1, wherein the at least one application module is configured to validate data inputted and transmitted to the network server.

5. The system of claim 4, wherein the inputted data is validated by comparing the inputted data with defined rules stored on the network server.

6. The system of claim 1, wherein the at least one application module is configured to permit a task administrator to assign multiple task lists to a single member.

7. The system of claim 1, wherein the at least one mobile transmission device includes a touch sensing surface for permitting data entry.

8. The system of claim 1, wherein communications between the network server and the at least one mobile transmission device is encrypted.

9. The system of claim 1, wherein the transmitted data is first saved and time and date stamped.

10. The system of claim 1, wherein the at least one mobile transmission device includes a GPS transmitter and receiver so that the location of the mobile transmission device can be tracked via a tracking application module, and wherein the location is transmitted from the mobile transmission device to the network server.

11. The system of claim 10, wherein a notification is sent to the network server indicating that the case manager's location is close to or the same as the member's location, and wherein upon receiving the notification a member's task list is transmitted to the mobile transmission device.

12. The system of claim 10, wherein the task list for a particular member may be transmitted at a defined time, to the mobile device

13. The system of claim 10, wherein the provider network server tracks the location of the case manager associated with the mobile transmission device using the transmitted location.

14. A mobile care management system for creating, storing and communicating information associated with a remote encounter between a case manager and a member of a mobile care network, comprising:
a provider server network accessible via a communication network and comprising a visit record application module for administering visit records of case managers, said visit record application module having at least one data input field for capturing and transmitting data input to the provider network server;
a database communicably linked to the provider server network, said database configured to transmit and receive data relating to a member, tasks assigned to a case manager during a visit and a visit record; and
at least one mobile transmission device associated with the case manager and configured to bidirectionally communicate with the provider server network via the communication network,
wherein the visit record application module administers visit records by transmitting to at least one mobile transmission device member information and assigned tasks, receiving from the at least one mobile transmission device captured, real-time data relating to tasks performed during a remote encounter between a case manager and a member of a mobile care network, evaluating the performance of the tasks, and storing the captured, real-time data and evaluation results, and
wherein the at least one mobile transmission device is used by the case manager to input and transmit data and information regarding verified, performed tasks back to the provider server network.

15. The system of claim 14, wherein the member information represents the member's care plan, personal information, medical information or signature.

16. The system of claim 14, wherein communications between the provider server network and the at least one mobile transmission device is encrypted.

17. The system of claim 6, wherein the transmitted data is first saved and time and date stamped.

18. The system of claim 14, wherein the at least one mobile transmission device includes a GPS transmitter and receiver so that the location of the mobile transmission device can be tracked, and wherein the location is transmitted from the mobile transmission device to the provider server system.

19. The system of claim 14, wherein the provider server network further comprises an enterprise application integration module for integrating with a third party application.

20. A method for acquiring and transmitting real-time data on and by a caregiver deployed to a remote site for the purpose of performing a task for a provider, comprising:
receiving at a mobile transmission device a data transmission across a bidirectional communication network from a provider server network, wherein the data transmission includes a list of assigned visits and tasks to be performed associated with a member of a mobile care network;
rendering a plurality of screens having data input fields, member information, and visit and task information on a display on the mobile transmission device;
accepting data inputs from a caregiver performing tasks, wherein the data inputs correspond to the tasks completed;
capturing an electronic verification of the member that assigned tasks were performed by the caregiver;
saving the inputted data, the electronic verification and time and date stamping the data;
creating a visit record comprising the inputted data, the electronic verification and time and date stamping the data; and
transmitting the visit record across the communication network to the provider server network.
